(19) United States
(12) Patent Application Publication
(10) Pub. No.: US 2010/0273522 A1
(43) Pub. Date: Oct. 28, 2010

(54) Wireless communication apparatus

(75) Inventors: Yasuji Ota, Kawasaki (JP); Masanao Suzuki, Kawasaki (JP); Kaori Endo, Kawasaki (JP); Takeshi Otani, Kawasaki (JP); Taro Togawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/659,850

(22) Filed: Mar. 23, 2010

(30) Foreign Application Priority Data
Apr. 23, 2009 (JP) 2009-105314

(51) Int. Cl. H04W 88/02; H04R 29/00

(52) U.S. Cl. 455/550.1; 381/56

(57) ABSTRACT

In a wireless communication apparatus, an ambient apparatus number measurement unit measures the number of wireless apparatuses existing around. A movement amount measurement unit detects acceleration at the time when its own apparatus moves and measures the movement amount of its own apparatus. An ambient sound analysis unit records ambient sounds and analyzes the recorded ambient sounds to generate ambient sound analysis information. A communication controller estimates surroundings of its own apparatus based on at least one of the number of the measured wireless apparatuses, the measured movement amount, and the ambient sound analysis information, and autonomously performs a communication control of its own apparatus according to the estimated surroundings.

### CROSS-REFERENCE TO RELATED APPLICATIONS

This application is based upon and claims the benefit of priority of the prior Japanese Patent Application No. 2009-105314, filed on Apr. 23, 2009, the entire contents of which are incorporated herein by reference.

### FIELD

The embodiment discussed herein is related to a wireless communication apparatus that performs a wireless communication.

### BACKGROUND

Wireless communication networks can constitute a core to form a base of information communication networks, and it is desired that services of the wireless communication networks become available in wider areas and further sophisticated. Toward an information society, development of the wireless communication networks is rapidly proceeding.

Particularly, a cellular phone penetration rate rapidly increases, and it is desired that a model whose listenability, viewability, and usability are improved for users is developed. Further, systems for measuring surrounding wireless environments and performing wireless control based on the measurement result have been developed in recent years.

For example, one conventional technique performs wireless control while monitoring a wireless link in a mobile ad hoc communications network, thereby establishing a link between a client Bluetooth (Bluetooth: trademark) apparatus and a server Bluetooth apparatus, and discovering services offered by the other Bluetooth apparatus (Published Japanese translation of a PCT application No. 2006-510124).

Another conventional technique performs wireless control while detecting a packet for priority communications to measure the number of priority communications and to measure the number of association terminals, and controlling the amount of packet traffic based on these measurement results (Japanese Laid-open Patent Publication No. 2007-134812).

When recognizing surroundings and performing wireless control as in the above-described conventional technique, a number of techniques are designed to grasp ambient terminal functions and the number of ambient terminals and to perform traffic control. Meanwhile, few techniques extend to such a level that a cellular phone user is now placed under what surroundings and cellular phone usability can be improved when what services are offered. Therefore, it is desired to develop a cellular phone in which autonomous control is performed depending on estimated surroundings of a user to improve usability for the user.

### SUMMARY

According to one aspect of the embodiment, there is provided a wireless communication apparatus. This wireless communication apparatus includes: an ambient apparatus number measurement unit that measures the number of ambient apparatuses existing around; a movement amount measurement unit that measures the movement amount of its own apparatus; an ambient sound analysis unit that analyzes ambient sounds to generate ambient sound analysis information; and a communication controller that estimates surroundings of its own apparatus based on at least one of the number of the ambient apparatuses, the movement amount, and the ambient sound analysis information and autonomously performs a communication control according to the surroundings.

The object and advantages of the invention will be realized and attained by unit of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 illustrates a configuration example of a wireless communication apparatus;

FIG. 2 illustrates an operation example at the time of measuring the number of ambient apparatuses;

FIG. 3 is the entire flowchart illustrating an estimation operation of surroundings; and

FIG. 4 illustrates a surrounding estimation table.

### DESCRIPTION OF EMBODIMENT(S)

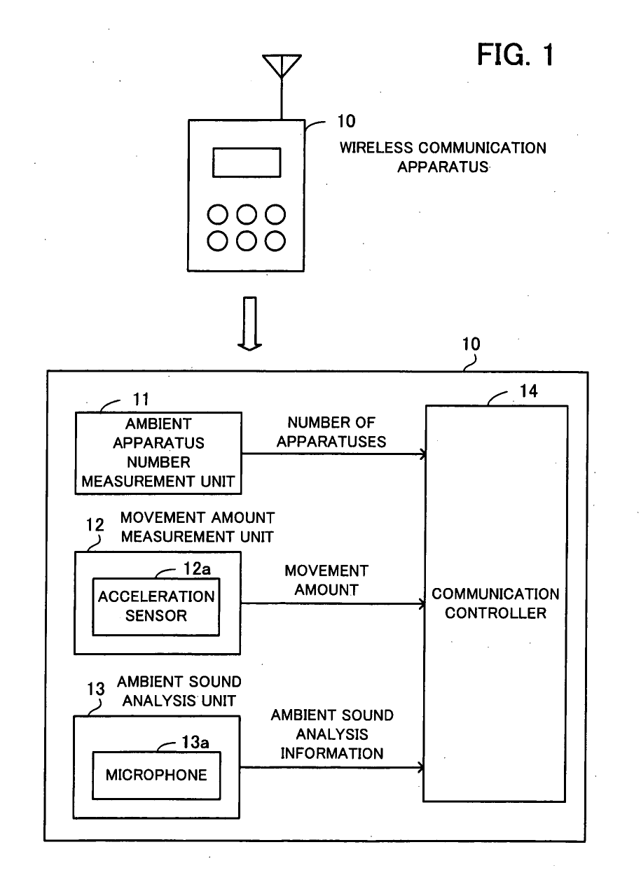

Embodiments of the present invention will be described in detail below with reference to the accompanying drawings, wherein like reference numerals refer to like elements throughout. FIG. 1 illustrates a configuration example of a wireless communication apparatus. A wireless communication apparatus 10 includes an ambient apparatus number measurement unit 11, a movement amount measurement unit 12, an ambient sound analysis unit 13, and a communication controller 14, and is an apparatus that performs a wireless communication. For example, the wireless communication apparatus 10 corresponds to a cellular phone.

The ambient apparatus number measurement unit 11 has a wireless communication interface function, and measures the number of apparatuses (wireless apparatuses) existing around via the wireless communication interface function. For example, the apparatuses existing around correspond to other cellular phones.

The movement amount measurement unit 12 includes an acceleration sensor 12a. Using the acceleration sensor 12a, the movement amount measurement unit 12 measures the movement amount (acceleration or speed) at the time when its own apparatus (wireless communication apparatus 10) moves. In the acceleration sensor 12a, a compact sensor with high precision is put to practical use by a MEMS (Micro Electro Mechanical System) technology. By the acceleration sensor 12a mounted within the apparatus, the movement amount measurement unit 12 can detect whether its own apparatus moves or remains stationary.

The ambient sound analysis unit 13 includes a microphone 13a corresponding to an acoustic sensor, and analyzes ambient sounds recorded by the microphone 13a to generate ambient sound analysis information. The communication controller 14 estimates surroundings of its own apparatus based on at least one of the number of the measured apparatuses, the measured movement amount, and the ambient sound analysis information. Then, the communication controller 14 autonomously performs a communication control according to the estimated surroundings.

Here, performance of the communication control according to the estimated surroundings is as follows. For example, when call-disabled surroundings are estimated, the communication controller 14 stops ringing a ringing tone as the communication control. Alternatively, when call-enabled surroundings are estimated, the communication controller 14 receives a call by ringing a ringing tone as the communication control. As described above, the wireless communication apparatus 10 performs an adaptive communication control so as to select a communication mode according to the estimated surroundings (details will be described below).

The ambient apparatus number measurement unit 11 will be described below. In an ad hoc network in which both terminals (wireless apparatuses) are directly connected to each other to establish a network, the terminal itself has a routing function, and performs a routing control for holding or finding a route for the wireless communication.

As a routing control system, a system referred to as a reactive routing control is used. In the reactive routing control system, when a data transfer is performed, a route is found. During the communication request, the presence of ambient terminals is further confirmed by emitting radio waves to prepare a routing table. The ambient apparatus number measurement unit 11 uses the routing control (e.g., reactive routing control) for use in the above-described ad hoc network to measure the number of apparatuses existing around.

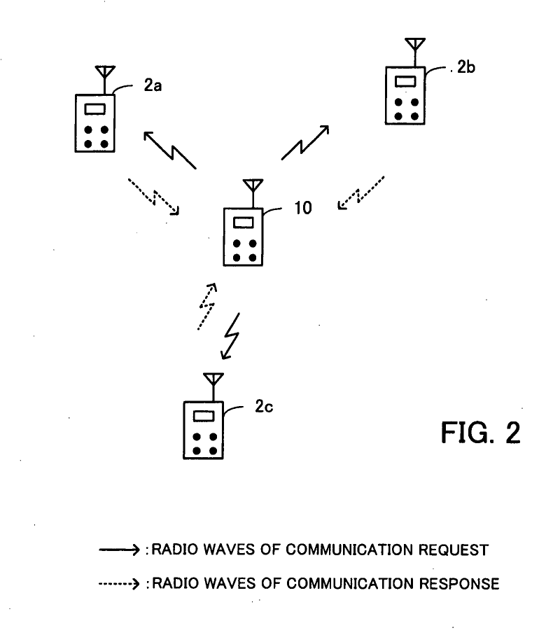

FIG. 2 illustrates an operation example at the time of measuring the number of ambient apparatuses. Wireless apparatuses 2a to 2c exist around the wireless communication apparatus 10. The ambient apparatus number measurement unit 11 of the wireless communication apparatus 10 and those of the wireless apparatuses 2a to 2c each have a short range wireless communication function for mutually emitting radio waves in a short range to recognize the presence of ambient apparatuses at the time of preparing the routing table.

When the wireless communication apparatus 10 measures the number of the ambient apparatuses here, the ambient apparatus number measurement unit 11 emits radio waves (radio waves of communication request) around. The radio waves reach the wireless apparatuses 2a to 2c, which each emit replay radio waves (radio waves of communication response) indicating that the radio waves are received. The ambient apparatus number measurement unit 11 receives the radio waves sent back from the wireless apparatuses 2a to 2c existing around, thereby measuring the number of the other wireless apparatuses existing around its own apparatus.

As described above, the ambient apparatus number measurement unit 11 can measure the number of apparatuses existing around by the use of the routing control for use in the ad hoc network. As another method, the ambient apparatus number measurement unit 11 may query the number of wireless apparatuses existing around to a network to which its own apparatus is wirelessly connected to obtain the number of the ambient apparatuses.

That is, with respect to a base station and server that locate within a wireless area in which the wireless communication apparatus 10 performs a wireless communication, the ambient apparatus number measurement unit 11 may query the number of the other wireless apparatuses existing within the wireless area to obtain the number of the ambient apparatuses.

As described above, the ambient apparatus number measurement unit 11 performs the routing control for use in the ad hoc network or an inquiry to the network, thereby accurately grasping the number of the adjacent wireless apparatuses.

As other methods, the ambient apparatus number measurement unit 11 has a wireless communication function such as a bluetooth and an infrared communication function (IrDA: Infrared Data Association), thereby detecting the wireless apparatuses existing around to measure the number of the ambient apparatuses. Further, the ambient apparatus number measurement unit 11 notifies its own information to each other by broadcasting, thereby detecting the wireless apparatuses existing around to measure the number of the ambient apparatuses.

The ambient sound analysis unit 13 will be described below. The ambient sound analysis unit 13 analyses the ambient sounds recorded by the microphone 13a to generate the ambient sound analysis information. Specifically, as the ambient sound analysis information, the ambient sound analysis unit 13 generates an ambient sound level and a voice analysis value.

For example, when a user is not in a call state (such a state can be recognized by detecting that a communication call is not established), the ambient sound level is a level value obtained by measuring the amplitude of ambient sounds, wherein an average level having a fixed time length is used. Based on the fact that this ambient sound level is high or low, the communication controller 14 can determine whether a surrounding area of the user using the wireless communication apparatus 10 is noisy or quiet.

The voice analysis value indicates a degree (degree of mixing) of voices included in the ambient sounds. When performing a spectral analysis of the ambient sounds, the ambient sound analysis unit 13 can detect voice (babble noise) components except a voice of the user Using the wireless communication apparatus 10. Based on the fact that the voice analysis value is high or low, the communication controller 14 can determine whether the user using the wireless communication apparatus 10 exists in the crush.

A method of calculating the ambient sound level will be described here. The ambient sound level can be found as a square mean value of an amplitude value of digital audio signals, and calculated by the following formula (1).

$$pow = \frac{1}{N} {\sum }_{i = 0}^{N - 1} {( x ( i ) )}^{2} \qquad ( 1 )$$

In the above formula (1), x(i) represents an input voice, and N represents the number of samples of a frame for calculating a power level. For example, when finding an average of ‘a’ seconds, N=8000x′a′ under 8 kHz sampling conditions. When comparing an ambient sound level power calculated by the formula (1) to a previously-set threshold, the communication controller 14 can estimate whether the wireless communication apparatus 10 is present in the crush.

For example, when −40 dBov corresponds to a border of the noise, the communication controller 14 sets 107374 (square value) equal to approximately −40 dBov as a threshold. If the ambient sound level power is larger than this threshold, the communication controller 14 determines that the surroundings are noisy. Meanwhile, if the ambient sound level power is equal to or smaller than this threshold, the communication controller 14 determines that the surroundings are quiet.

Next, a method of calculating the voice analysis value will be described. For one example of detecting the degree of included voices, a linear prediction analysis method of identifying as a linear filter a transfer function for a generation process of a voice can be used. This method is a method of identifying, using a linear filter having a plurality of poles, modulation characteristics in which a sound signal passes through a vocal tract and is colored to a timbre. This method is used in an audio coding technology.

As illustrated in the following formula (2), this linear prediction analysis method is a linear coupling using past signals in the number of p, namely, a method of predicting present signals by using a linear filter.

$${x}_{a} ( n ) = {\sum }_{i = 1}^{p} {α}_{i} \cdot x ( n - i ) \qquad ( 2 )$$

In the above formula (2), xₐ(n) represents a present prediction sample, αᵢ represents a prediction coefficient, p represents a prediction order, and x(n−i) represents a past prediction sample. The prediction coefficient can be found as a coefficient for minimizing an error (e(n) illustrated in formula (3)) between a prediction sample and a real sample (e.g., the prediction coefficient can be found by a recursive solution of Durbin from an equation of an autocorrelation technique).

e(n)=x(n)−xₐ(n) (3)

A power ratio (prediction gain) between an audio signal x(n) supplied to a linear prediction filter and a prediction residual signal e(n) produced from the linear prediction filter corresponds to a linear prediction performance, and a degree of voices can be estimated from this prediction gain value.

Specific prediction gain Gₚ is calculated by formula (4).

$${G}_{p} = \frac{1}{{\sum }_{i = 0}^{p} {α}_{i} \cdot {γ}_{i}} = \frac{1}{{\prod }_{i = 1}^{p} ( 1 - {k}_{i}^{2} )} \qquad ( 4 )$$

In the above formula (4), γᵢ represents an autocorrelation coefficient, and kᵢ represents a partial autocorrelation coefficient. Since the prediction gain value is known to be 10 to 14 dB in the case of voice, if the prediction gain value is equal to or smaller than the threshold of 0.3, the communication controller 14 determines that a mixing degree of voices is high.

On the other hand, as another method of estimating characteristics of a voice, pitch can also be used. The pitch is periodicity corresponding to a period of vibration of a vocal cord. If a period is short, a tone of a voice is high, whereas if a period is long, a tone of a voice is low. This corresponds to the fact that a correlation corresponding to a period length increases among samples. A correlation value (pitch correlation value) that gives a maximum value of the correlation in a period L can be calculated by formula (5).

$${P}_{L} = \frac{{\sum }_{i = 0}^{N - 1} {( x ( n - i ) \cdot x ( n - L - i ) )}^{2}}{{\sum }_{i = 0}^{N - 1} {( x ( n - i ) )}^{2}} \qquad ( 5 )$$

The pitch correlation value takes a value of 0 to 1.0, and as its value is closer to 1.0, the pitch periodicity of the voice is high. Therefore, for example, if the prediction gain value is larger than the threshold of 0.7 and the pitch correlation value is equal to or larger than 0.7, the communication controller 14 determines that the mixing degree of voices is high. Accordingly, the above-described prediction gain value and pitch correlation value can be used as a value indicating voice.

Next, specific examples in the case of performing the communication control according to the estimated surroundings will be described. First, four thresholds of the communication controller 14 will be described. The communication controller 14 sets a first threshold (hereinafter, referred to as an apparatus number threshold) over which the number of the ambient apparatuses is considered large. The communication controller 14 sets a second threshold (hereinafter, referred to as a volume threshold) over which a volume level of the ambient sounds is considered high.

The communication controller 14 sets a third threshold (hereinafter, referred to as a voice threshold) over which a degree of voices included in the ambient sounds is considered high. In addition, the communication controller 14 sets a fourth threshold (hereinafter, referred to as a movement amount threshold) over which a moving speed of its own apparatus is considered fast, that is, its own apparatus is considered to be moving.

The communication controller 14 performs at least one comparison processing among comparisons between the number of apparatuses and the apparatus number threshold, the ambient sound level and the volume threshold, the voice analysis value and the voice threshold, and the movement amount and the movement amount threshold, thereby appropriately estimating surroundings to perform the communication control according to the estimated surroundings.

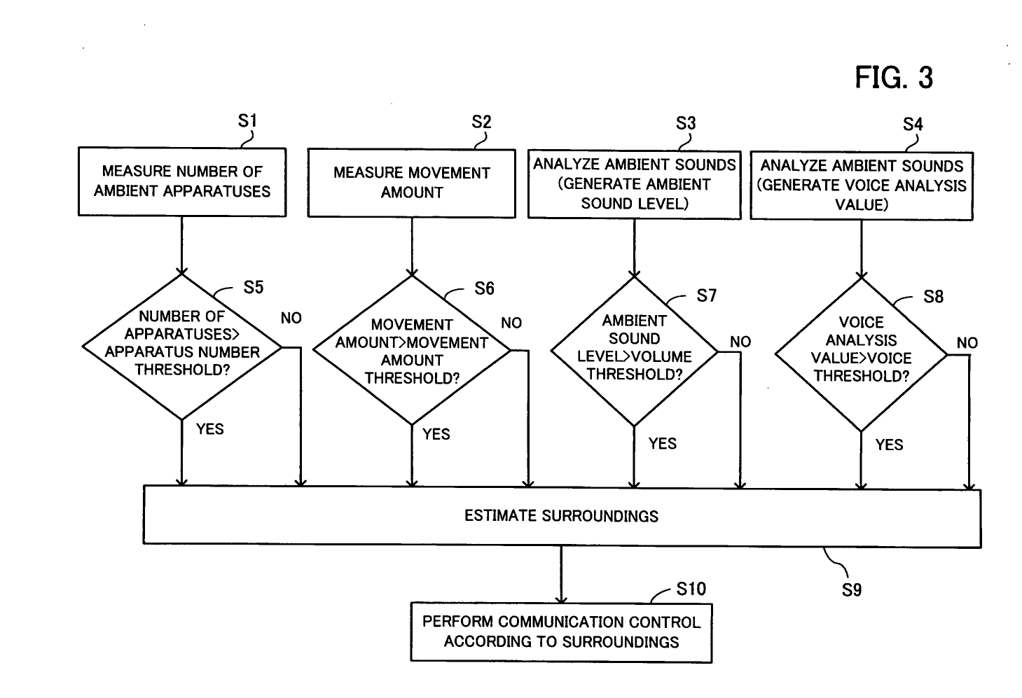

FIG. 3 is the entire flowchart illustrating estimation operations of the surroundings.

[S1] The ambient apparatus number measurement unit 11 measures the number of the ambient apparatuses.

[S2] The movement amount measurement unit 12 measures the movement amount of its own apparatus.

[S3] The ambient sound analysis unit 13 analyzes the ambient sounds to generate the ambient sound level.

[S4] The ambient sound analysis unit 13 analyzes the ambient sounds to generate the voice analysis value.

[S5] The communication controller 14 performs a comparison between the number of apparatuses measured by the ambient apparatus number measurement unit 11 and the previously-set apparatus number threshold to output a comparison result.

[S6] The communication controller 14 performs a comparison between the movement amount measured by the movement amount measurement unit 12 and the previously-set movement amount threshold to output a comparison result.

[S7] The communication controller 14 performs a comparison between the ambient sound level generated by the ambient sound analysis unit 13 and the previously-set volume threshold to output a comparison result.

[S8] The communication controller 14 performs a comparison between the voice analysis value generated by the ambient sound analysis unit 13 and the previously-set voice threshold to output a comparison result.

[S9] The communication controller 14 estimates surroundings based on the comparison results output in steps S5 to S8.

[S10] The communication controller 14 autonomously performs the communication control according to the present surroundings based on the estimation results of the surroundings.

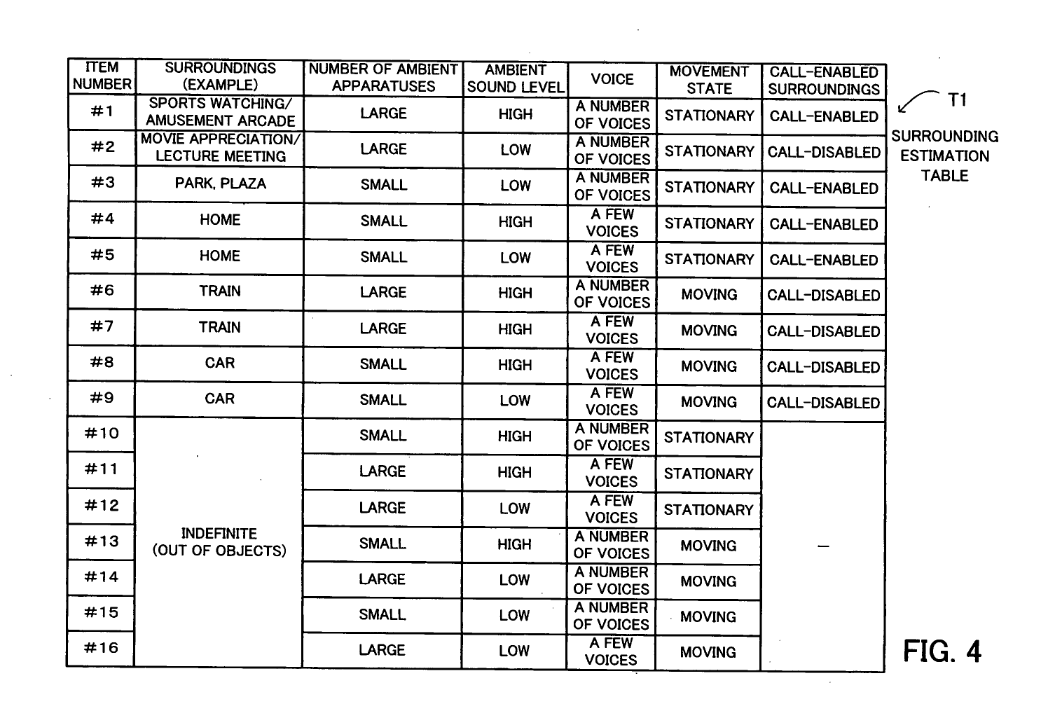

FIG. 4 illustrates a surrounding estimation table. A surrounding estimation table T1 illustrates states (of 2⁴ ways) based on the determination of YES or NO illustrated in steps S5 to S8 in FIG. 3. The surrounding estimation table T1 includes attribute items such as item numbers, surroundings, number of ambient apparatuses, an ambient sound level, voice, a movement state, and call-enabled surroundings. Information on the surrounding estimation table T1 is stored within a memory of the communication controller 14.

### On the Item Number #1 of the Surrounding Estimation Table T1

Suppose that the communication controller 14 determines that the number of the ambient apparatuses is larger than the apparatus number threshold (defined as a determination result a1) and that the ambient sound level is higher than the volume threshold (defined as a determination result a2).

Further, suppose that the communication controller 14 determines that the voice analysis value is larger than the voice threshold (defined as a determination result a3) and that the movement amount is equal to or smaller than the movement amount threshold (defined as a determination result a4).

In this case, the communication controller 14 estimates that a number of persons are present around from the determination result a1, the surroundings are noisy from the determination result a2, a number of voices are included from the determination result a3, and its own apparatus remains stationary from the determination result a4. The communication controller 14 estimates that the above-described surroundings are call-enabled surroundings and, for example, that the user exists in a sports stadium or amusement arcade.

Accordingly, as one example of the communication control, the communication controller 14 performs the communication control of ringing a ringing tone at the time of receiving a call. Alternatively, the communication controller 14 may perform the communication control of gradually increasing a ringing tone to receive a call.

### On the Item Number #2 of the Surrounding Estimation Table T1

Suppose that the communication controller 14 determines that the number of the ambient apparatuses is larger than the apparatus number threshold (defined as a determination result b1) and that the ambient sound level is equal to or lower than the volume threshold (defined as a determination result b2).

Further, suppose that the communication controller 14 determines that the voice analysis value is larger than the voice threshold (defined as a determination result b3) and that the movement amount is equal to or smaller than the movement amount threshold (defined as a determination result b4).

In this case, the communication controller 14 estimates that a number of persons are present around from the determination result b1, the surroundings are quiet from the determination result b2, a number of voices are included from the determination result b3, and its own apparatus remains stationary from the determination result b4. The communication controller 14 estimates that the above-described surroundings are call-disabled surroundings and, for example, that the user exists in a movie theater or conference room of a lecture meeting.

Accordingly, as one example of the communication control, the communication controller 14 performs the communication control of stopping ringing a ringing tone at the time of receiving a call. Alternatively, the communication controller 14 prevents the user from receiving a call by ringing a ringing tone, and may perform the communication control of switching to a manner mode setting or automatic voice response.

### On the Item Number #3 of the Surrounding Estimation Table T1

Suppose that the communication controller 14 determines that the number of the ambient apparatuses is equal to or smaller than the apparatus number threshold (defined as a determination result c1) and that the ambient sound level is equal to or lower than the volume threshold (defined as a determination result c2).

Further, suppose that the communication controller 14 determines that the voice analysis value is larger than the voice threshold (defined as a determination result c3) and that the movement amount is equal to or smaller than the movement amount threshold (defined as a determination result c4).

In this case, the communication controller 14 estimates that a few persons are present around from the determination result c1, the surroundings are quiet from the determination result c2, a number of voices are included from the determination result c3, and its own apparatus remains stationary from the determination result c4. The communication controller 14 estimates that the above-described surroundings are call-enabled surroundings and, for example, that the user exists in a park or plaza. Accordingly, as one example of the communication control, the communication controller 14 performs the communication control of ringing a ringing tone at the time of receiving a call.

### On the Item Numbers #4 and #5 of the Surrounding Estimation Table T1

Suppose that the communication controller 14 determines that the number of the ambient apparatuses is equal to or smaller than the apparatus number threshold (defined as a determination result d1) and that the voice analysis value is equal to or smaller than the voice threshold (defined as a determination result d2).

Further, suppose that the communication controller 14 determines that the movement amount is equal to or smaller than the movement amount threshold (defined as a determination result d3). Suppose that the ambient sound level may be higher or lower than the volume threshold.

In this case, the communication controller 14 estimates that a few persons are present around from the determination result d1, a few voices are included from the determination result d2, and its own apparatus remains stationary from the determination result d3. The communication controller 14 estimates that the above-described surroundings are call-enabled surroundings and, for example, that the user is present at home. Accordingly, as one example of the communication control, the communication controller 14 performs the communication control of ringing a ringing tone at the time of receiving a call.

### On the Item Numbers #6 and #7 of the Surrounding Estimation Table T1

Suppose that the communication controller 14 determines that the number of the ambient apparatuses is larger than the apparatus number threshold (defined as a determination result e1) and that the ambient sound level is higher than the volume threshold (defined as a determination result e2).

Further, suppose that the communication controller 14 determines that the movement amount is larger than the movement amount threshold (defined as a determination result e3). Suppose that the voice analysis value may be larger or smaller than the voice threshold.

In this case, the communication controller 14 estimates that a number of persons are present around from the determination result e1, the surroundings are not quiet from the determination result e2, and its own apparatus moves from the determination result e3. The communication controller 14 estimates that the above-described surroundings are call-disabled surroundings and, for example, that the user is present in a train.

Accordingly, as one example of the communication control, the communication controller 14 performs the communication control of stopping ringing a ringing tone at the time of receiving a call. Alternatively, the communication controller 14 may perform the communication control of preventing the user from receiving a call by ringing a ringing tone and of switching to a manner mode setting or automatic voice response.

### On the Item Numbers #8 and #9 of the Surrounding Estimation Table T1

Suppose that the communication controller 14 determines that the number of the ambient apparatuses is equal to or smaller than the apparatus number threshold (defined as a determination result f1) and that the voice analysis value is equal to or smaller than the voice threshold (defined as a determination result f2).

Further, suppose that the communication controller 14 determines that the movement amount is larger than the movement amount threshold (defined as a determination result f3). Suppose that the ambient sound level may be higher or lower than the volume threshold.

In this case, the communication controller 14 estimates that a few persons are present around from the determination result f1, a few voices are included from the determination result f2, and its own apparatus moves from the determination result f3. The communication controller 14 estimates that the above-described surroundings are call-disabled surroundings and, for example, that the user drives in a car. Accordingly, as one example of the communication control, the communication controller 14 may perform the communication control of preventing the user from receiving a call by ringing a ringing tone (and of switching to a manner mode setting or automatic voice response).

Surroundings on the item numbers #10 to #16 of the surrounding estimation table T1 are excluded from control objects. In the above description, the communication controller 14 is assumed to perform the communication control of ringing a ringing tone in call-enabled surroundings. Alternatively, the communication controller 14 may perform the communication control of switching to a manner mode setting also in call-enabled surroundings.

The above-described content of the communication control under the estimated surroundings is one example. According to the surroundings, the user can freely set what communication control should be performed to the communication controller 14 through the user interface function provided on the wireless communication apparatus 10. Also in relation to the four thresholds described above, the user can arbitrarily change a set value.

In the above description, the number of the ambient apparatuses, the ambient sound level, the voice, and the movement amount are taken into consideration for estimation of the surroundings. Position information measured by GPS (global positioning system) may be further used as information for estimating the surroundings, and is combined with the four information units, thereby further improving the accuracy.

When using the position information obtained from GPS, the user using the wireless communication apparatus 10 can recognize what geographical environment and use the position information at the time of determining whether that place is a call-enabled area.

As described above, the wireless communication apparatus 10 is configured to perform the communication control in which an appropriate communication mode is adopted according to the estimated surroundings. A user himself or herself is conventionally demanded to arbitrarily change the setting of a cellular phone, for example, from the viewpoint of a manner at the time of using a cellular phone. However, the user bears a heavy burden when changing the setting in each case according to a sequentially-changing ambient environment.

As compared with the conventional case, the wireless communication apparatus 10 estimates surroundings of a user, determines whether the surroundings are call-enabled surroundings or call-disabled surroundings, and adaptively performs a switching control of the communication mode according to the estimated surroundings. Therefore, the wireless communication apparatus 10 can realize a remarkable improvement in user-friendliness.

As described above, the wireless communication apparatus 10 is configured to estimate surroundings of its own apparatus based on the number of apparatuses, the movement amount, and the ambient sound analysis information, and to autonomously control a communication format of its own apparatus according to the estimated surroundings. As a result, the wireless communication apparatus 10 can perform the communication control taken into consideration up to the surroundings of the user and, therefore, dramatically improve user-friendliness.

The wireless communication apparatus 10 uses the wireless communication interface, acceleration sensor, and microphone standard-mounted on a normal cellular phone, and obtains information for estimating the surroundings from the above-described device functions to perform the adaptive communication control. The wireless communication apparatus 10 can therefore perform the communication control by changing only embedded software. Accordingly, since a new hardware need not be added, the wireless communication apparatus 10 can realize improvement in serviceability with low cost. The proposed wireless communication apparatus 10 can realize improvement in user-friendliness.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that various changes, substitutions and alterations could be made hereto without departing from the spirit and scope of the invention.

What is claimed is:

1. A wireless communication apparatus, comprising:
an ambient apparatus number measurement unit that measures the number of ambient apparatuses existing around;
a movement amount measurement unit that measures the movement amount of its own apparatus;
an ambient sound analysis unit that analyzes ambient sounds to generate ambient sound analysis information; and
a communication controller that estimates surroundings of its own apparatus based on the number of the ambient apparatuses, the movement amount, or the ambient sound analysis information, or any combination thereof, and autonomously performs a communication control according to the surroundings.

2. The wireless communication apparatus according to claim 1, wherein:
the ambient apparatus number measurement unit includes a short range wireless communication function for emitting and receiving radio waves in a short range and recognizing presence of the ambient apparatuses, whereby the ambient apparatus performs short range wireless communication with the ambient apparatuses having the short range wireless communication function, and measures the number of the ambient apparatuses.

3. The wireless communication apparatus according to claim 1, wherein:
the ambient apparatus number measurement unit queries the number of the ambient apparatuses existing around to a host or a server to which its own apparatus is wirelessly connected, and obtains the number of the ambient apparatuses.

4. The wireless communication apparatus according to claim 1, wherein:
the ambient sound analysis unit generates, as the ambient sound analysis information, an ambient sound level being a power amplification level of ambient sounds, a voice analysis value indicating a degree of voices included in ambient sounds, or a combination thereof.

5. The wireless communication apparatus according to claim 4, wherein:
the communication controller sets a first threshold over which the number of the ambient apparatuses is considered large,
a second threshold over which the ambient sound level is considered high,
a third threshold over which the degree of voices indicated by the voice analysis value is considered high, and
a fourth threshold over which a speed of movement of its own apparatus is considered fast; and
the communication controller performs a comparison between the number of the ambient apparatuses and the first threshold, a comparison between the ambient sound level and the second threshold, a comparison between the voice analysis value and the third threshold, or a combination between the movement amount and the fourth threshold, or any combination thereof, to estimate the surroundings to perform the communication control according to the estimated surroundings.

6. The wireless communication apparatus according to claim 5, wherein:
the communication controller estimates the surroundings to be call-enabled surroundings when determining that the number of the ambient apparatuses is larger than the first threshold, the ambient sound level is higher than the second threshold, the voice analysis value is larger than the third threshold, and the movement amount is equal to or smaller than the fourth threshold,
the surroundings to be call-disabled surroundings when determining that the number of the ambient apparatuses is larger than the first threshold, the ambient sound level is equal to or lower than the second threshold, the voice analysis value is larger than the third threshold, and the movement amount is equal to or smaller than the fourth threshold,
the surroundings to be call-enabled surroundings when determining that the number of the ambient apparatuses is equal to or smaller than the first threshold, the ambient sound level is equal to or lower than the second threshold, the voice analysis value is larger than the third threshold, and the movement amount is equal to or smaller than the fourth threshold,
the surroundings to be call-enabled surroundings when determining that the number of the ambient apparatuses is equal to or smaller than the first threshold, the voice analysis value is equal to or smaller than the third threshold, and the movement amount is equal to or smaller than the fourth threshold,
the surroundings to be call-disabled surroundings when determining that the number of the ambient apparatuses is larger than the first threshold, the ambient sound level is higher than the second threshold, and the movement amount is larger than the fourth threshold, and
the surroundings to be call-disabled surroundings when determining that the number of the ambient apparatuses is equal to or smaller than the first threshold, the voice analysis value is equal to or smaller than the third threshold, and the movement amount is larger than the fourth threshold.

7. The wireless communication apparatus according to claim 1, wherein:
the communication controller rings, when estimating the surroundings to be call-enabled surroundings, a ringing tone at the time of receiving a call as the communication control; and
the communication controller stops, when estimating the surroundings to be call-disabled surroundings, ringing a ringing tone at the time of receiving a call as the communication control.
